(19) United States
(12) Patent Application Publication
(10) Pub. No.: US 2017/0237613 A1
(43) Pub. Date: Aug. 17, 2017

(54) DEVICE CONFIGURATION-BASED FUNCTION DELIVERY

(71) Applicant: Google Inc., Mountain View, CA (US)

(72) Inventor: Shumeet Baluja, Leesburg, VA (US)

(73) Assignee: Google Inc., Mountain View, CA (US)

(21) Appl. No.: 15/584,970

(22) Filed: May 2, 2017

Related U.S. Application Data
(63) Continuation of application No. 15/189,826, filed on Jun. 22, 2016.
Application No. 15/189,826 is a continuation of application No. 10/880,868, filed on Jun. 30, 2004, now abandoned.

(51) Int. Cl. H04L 12/24; H04L 29/08; G06Q 30/02

(52) U.S. Cl. CPC H04L 41/0806; G06Q 30/0267; H04L 67/02; H04L 67/327

(57) ABSTRACT

The present disclosure is directed to a system for device configuration-based function delivery. A server receives a data structure including device configuration information that indicates the computing device comprises an application programming interface to allow a data function to access a call function of the computing device. The server identifies a first content item having a call-on-select function and a second content item without a call-on-select function. The server determines, based on the device configuration information, a first call score for the first content item having the call-on-select function and a second call score for the second content item without the call-on-select function. The server selects the second content item for transmission to the computing device to cause the computing device to display the second content item without the call-on-select function on the computing device comprising the application programming interface.

### §0. CROSS-REFERENCE TO RELATED APPLICATIONS

This application claims the benefit of priority under 35 U.S.C. §120 as a continuation of U.S. patent application Ser. No. 15/189,826, filed Jun. 22, 2016, which claims the benefit of priority under 35 U.S.C. §120 as a continuation of U.S. patent application Ser. No. 10/880,868, filed Jun. 30, 2004, each of which are hereby incorporated herein by reference in their entirety.

### §1. BACKGROUND

§1.1 Field of the Disclosure

The present disclosure concerns electronic content items, such as those served in an online environment. In particular, the present disclosure concerns adapting an online electronic document environment to make content items more useful for devices with call functionality, and/or a limited ability to render Web pages in a manner satisfying to a user (e.g., due to small displays, slow communications connection speeds, and/or slow rendering), such as mobile phones for example.

§1.2 Background Information

Content items can be provided for display on computing devices using the Internet. They can be selected responsive to a search query input in a search engine, or based on a document requested by the computing device. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Bucheit as inventors, and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal and Narayanan Shivakumar as inventors, describe methods and apparatus for serving content items relevant to the content of a document, such as a Web page for example.

Content items can be displayed in association with an online document, such as a search results page, or a Webpage with content for example. Online content items can include embedded information (e.g., links) such that when the content item is selected (e.g., by a user clicking on the content item), a browser is loaded with a document (e.g., a Webpage) associated with the content item. Such a document can be referred to as the “landing page” of the content item.

Although using Web pages, such as those authored in HTML or some other markup language for example, as content item landing pages is useful when the user is using a browser on a device with an adequate display monitor (e.g., 13″, 15″, 17″, 19″, 21″, etc., or perhaps even smaller), the use of the same Web pages as content item landing pages is much less useful when the user is using a device with a smaller and/or lower resolution display. Similarly, although using Web pages as content item landing pages is useful when the user device has an adequate communications connection to the Internet (e.g., a 56 Kbps modem, a higher speed digital subscriber line (DSL) modem, or a higher speed cable modem) and an adequate processor for rendering the Web page, using Web pages as content item landing pages is much less useful when the user device has a slow communications connection (e.g., 9.6 Kbps) and/or a slow processor.

### §2. SUMMARY OF THE DISCLOSURE

At least one aspect is directed to a system for device configuration-based function delivery. The system includes a server comprising one or more processors and memory to: receive, from a computing device via a computer network, a data structure including device configuration information that indicates the computing device comprises an application programming interface to allow a data function to access a call function of the computing device; to identify, responsive to a request from the computing device that accessed a webpage having content, a first content item having a call-on-select function and a second content item without a call-on-select function; to determine, based on the content of the web page accessed by the computing device, a first document score for the first content item and a second document score for the second content item, the second document score greater than the first document score; to determine, based on the device configuration information that indicates the computing device comprises the application programming interface to allow the data function to access the call function of the computing device, a first call score for the first content item having the call-on-select function and a second call score for the second content item without the call-on-select function, the second call score less than the first call score; to combine the first document score with the first call score to generate a first overall score for the first content item; to combine the second document score with the second call score to generate a second overall score for the second content item, the second overall score greater than the first overall score; and to select, based on the second overall score being greater than the first overall score, the second content item for transmission, via the computer network, to the computing device to cause the computing device to display, with the content of the webpage, the second content item without the call-on-select function on the computing device comprising the application programming interface to allow the data function to access the call function of the computing device. The present disclosure may be used to consider a user device type, such as whether or not the user device has call functionality, in serving content items. For example, at least some embodiments consistent with the present disclosure may (a) accept a request for one or more content item, (b) determine characteristics of a user device associated with the request, and (c) determine a set of content items to serve using the determined characteristics.

In at least some embodiments consistent with the present disclosure, the user device characteristics may include one or more of (i) whether or not the user device has call functionality, (ii) whether or not the user device is “limited”, (iii) whether or not the user device has a small display, (iv) whether or not the user device has a low resolution display, (v) whether or not the user device has a slow communications connection speed, (vi) whether or not the user device has a slow processor, (vii) whether or not the user device has a limited user input interface, etc.

### §3. BRIEF DESCRIPTION OF THE DRAWINGS

FIG. 1 is a high-level diagram showing parties or entities that can interact with a system.

FIG. 2 is a diagram illustrating an environment in which, or with which, the present invention may operate.

FIG. 3 is a Venn diagram illustrating a classification of user devices consistent with the present invention.

FIGS. 4 and 5 are diagrams of a mobile telephone with which with the present invention may be used.

FIG. 6 illustrates an exemplary data structure for storing a request message in a manner consistent with the present invention.

FIG. 7 is a flow diagram of an exemplary method for performing serve operations in a manner consistent with the present invention.

FIGS. 8-12 are exemplary displays consistent with the present invention.

FIG. 13 is a flow diagram of an exemplary method for performing user selection operations in a manner consistent with the present invention.

FIG. 14 is a block diagram of an exemplary apparatus that may perform various operations in a manner consistent with the present invention.

### §4. DETAILED DESCRIPTION

The present invention may involve novel methods, apparatus, message formats, and/or data structures for considering device type information such as display size and/or resolution, communications connection speed, processor speed, and/or call functionality for example, in an on-line advertising environment. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventor regards his invention as any patentable subject matter described.

In the following, environments in which, or with which, embodiments consistent with the present invention may operate are described in §4.1. Then, exemplary embodiments consistent with the present invention are described in §4.2. Examples of operations are provided in §4.3. Finally, some conclusions regarding the present invention are set forth in §4.4.

### §4.1 Environments in which, or with which, Embodiments Consistent with the Present Invention May Operate

### §4.1.1 Exemplary Advertising Environment

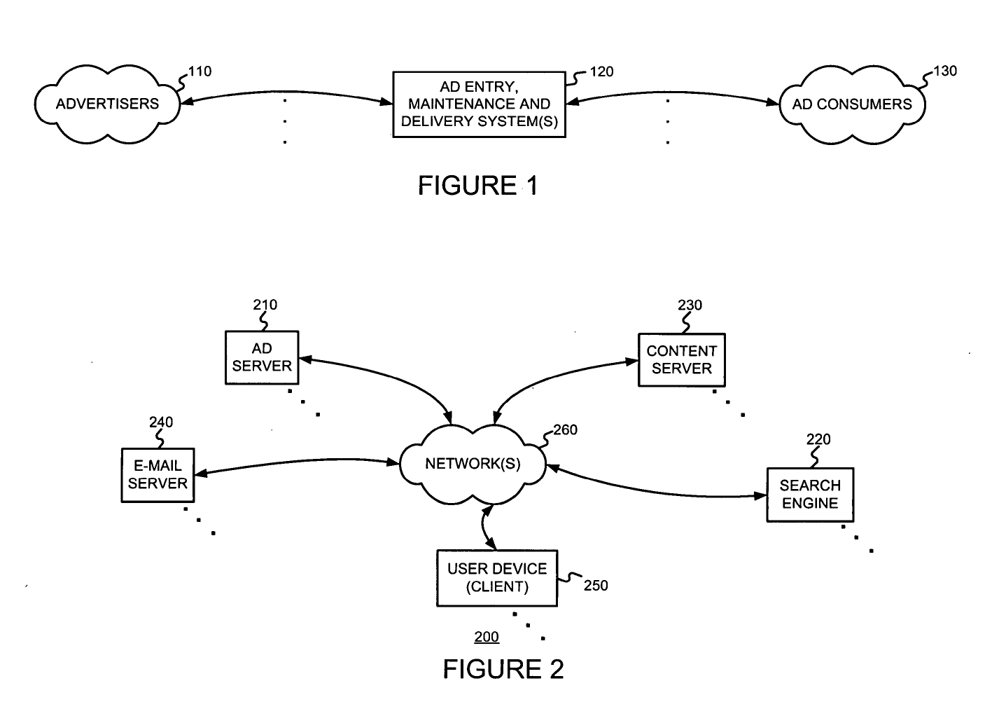

FIG. 1 is a high level diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or click-through related to the ad occurred) to the system 120. This usage information may include measured or observed user behavior related to ads that have been served.

The ad server 120 may be similar to the one described in FIG. 2 of the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, geolocation information, user profile information, user device characteristics, etc.), and price or offer information (e.g., maximum cost or cost per selection, maximum cost or cost per conversion, etc.)). Alternatively, or in addition, each ad group may include an average cost (e.g., average cost per selection, average cost per conversion, etc.). Therefore, a single maximum cost and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server) and/or a telephone number. Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer and pocket-PC Explorer browsers from Microsoft, the Opera Web Browser from Opera Software of Norway, the Navigator browser from AOL/Time Warner, the Mozilla browser, etc.), an e-mail facility (e.g., Outlook from Microsoft), etc. A search engine 220 may permit user devices 250 to search collections of documents (e.g., Web pages). A content server 210 may permit user devices 250 to access documents. An e-mail server (such as Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application (introduced above), ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, user device characteristics, etc. The request may also include end user device characteristics.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, end user device characteristics, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate, and/or as described below, information related to, and/or derived from, the search query), user device characteristics, and/or information associated with, or based on, the search results. Such information may include, for example, identifiers related to the search results (e.g., document identifiers or “dociDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc. The request may also include end user device characteristics.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, end user device characteristics, etc.) back to the ad server 120/210. As described below, such information may include information for determining on what basis the ad was determined relevant (e.g., strict or relaxed match, or exact, phrase, or broad match, etc.) Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### §4.1.2 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications. Finally, in some systems, an advertiser may specify that its ad is to be served only to (or is not to be served to) user devices having certain characteristics.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Mozilla), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

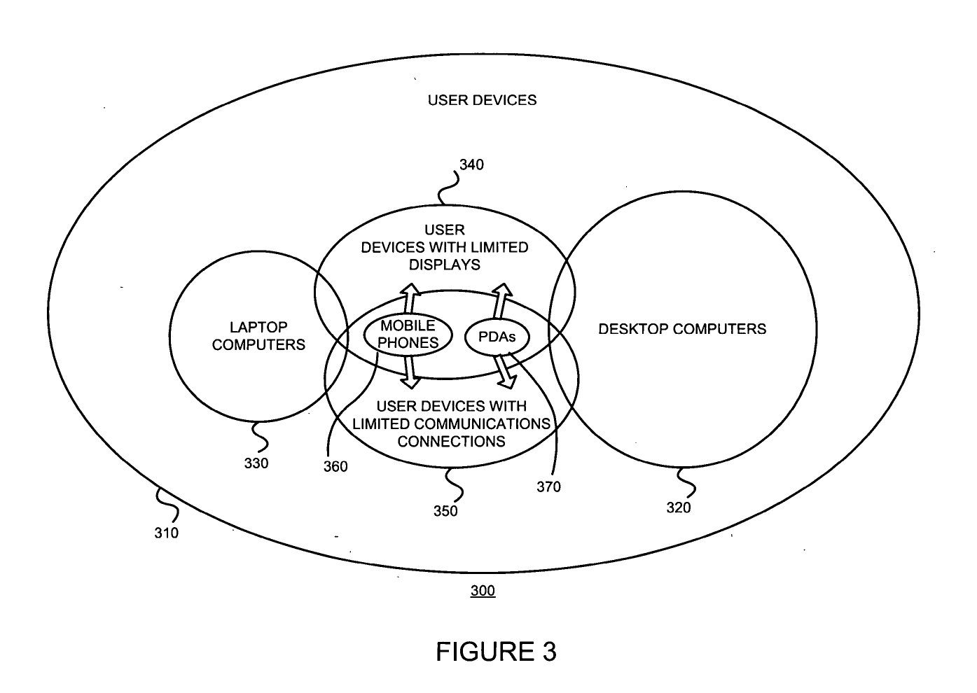

FIG. 3 is a Venn diagram illustrating a classification of user devices 300 consistent with the present invention. Some user devices 340 may have limited displays. Some user devices 350 may have limited communications connections. Most laptop computers 330 will not have limited displays or communications connections, but some may have limited displays and/or limited communications connections. Similarly, most desktop computers 320 will not have limited displays or communications connections, but some may have limited displays and/or limited communications connections. As shown, most present mobile telephones 360 and personal digital assistants (PDAs) 370 have limited displays and limited communications connections. However, as indicated by the arrows, displays and/or communications connections of such devices may improve. Similarly, other devices (not shown), such as handheld and/or wireless devices may have limited displays and/or limited communications connections.

A limited or small display may be thought of as one that cannot render Web pages in a manner satisfying to most users, or a target set of users, due to size, and/or resolution. A 3″ diagonal display common on most current generation PDAs is one example of a limited display in the context of most Web pages authored for personal computers. A 1.5″ diagonal display common on most mobile telephones is another example of a limited display in the context of most Web pages authored for personal computers. Similarly, a slow communications connection speed may be thought of as one that is too slow to permit loading Web pages in a manner satisfying to most users, or a target set of users. A 9.3 Kbps modem is one example of a slow connection speed in the context of loading most Web pages authored for personal computers. Similarly, a slow processor may be thought of as one that is too slow to permit a loaded Web page to be rendered in a manner satisfying to most users, or a target set of users. Finally, a limited user device may be thought of as one that cannot render requested Web pages in a manner satisfying to most users, or a target set of users (e.g., due to some combination of screen size, communications connection speed, and/or processor speed). What constitutes a limited user device, a limited display, a slow connection speed, and/or a slow processor may be defined by an advertiser, an ad serving system, an end user, or some combination of definitions from these parties and entities.

“Device information” about a client device or an end user device may include information about whether or not the device has call functionality, a home-base area code of the device, an area code of a present location of the device, qualitative and/or quantitative information about processor speed, display size, display resolution, communications speed, etc. of the device, etc.

Although the present invention may be used with any user device having telephone call functionality, it is especially advantageous for use with user devices having telephone call functionality but having small displays, slow communications connections, and/or slow processors.

### §4.2 Exemplary Embodiments

As discussed above, rendering a linked landing Web page upon ad selection in accordance with standard clickthrough model might not be advisable for devices with limited displays and/or limited communications connections, such as wireless browsers. For example, the advertiser's linked Website or Web page might not look good, and indeed might not even function, on a wireless telephone with rendering capabilities. In such a case, rendering or trying to render an ad landing page when an ad is selected may be harmful and make the advertiser look bad. As another example, making a connection and downloading another Web page may be quite slow for devices with limited communications connections. For example, Sprint's wireless network has been only 9.6K baud. Making the user incur another delay before getting a potentially mediocre experience might not be advisable. Further, on devices with limited displays, it is more difficult, perceptually, to keep track of one's state; making the user look at an intermediate text page will only serve to exacerbate this difficulty. Even if the advertiser's landing Web page and Website function well on a device with a limited display and/or communications connection, such as a mobile telephone, the chances of a conversion (e.g., a transaction being consummated) may remain quite small due to input limitations of mobile telephones. For example; entering shipping information and credit card information with a mobile telephone keyboard may be slow and frustrating. Finally, even if the user device is not limited in terms of rendering a selected Web page, it may nonetheless be advantageous to provide an ad with call-on-select functionality since such ads may have a higher conversion rate than ads in which a landing Web page is loaded in response to a selection.

The present invention may be used to (i) provide user device information (such as whether or not the user device has a slow display, a slow communication connection, a slow processor, a limited user input, and/or call functionality) in an ad request, (ii) select and/or score ads using user device information, (iii) display or otherwise render ads with a call-on-select feature, and/or (iv) initiate a call responsive to a call selection. The present invention may do so using various techniques, described below. As will be appreciated by those skilled in the art, at least some of these techniques may be used alone, or in combination.

Some of the exemplary embodiments are described below with respect to a mobile telephone. In some of the exemplary embodiments described below, a call-on-select “button”, such as a telephone icon for example, is displayed with (e.g., within, adjacent to, etc.) an advertisement. The call-on-select button indicates that if the user clicks the button (or perhaps other portions of the ad), a call will be generated from the mobile telephone. These exemplary embodiments have a number of advantages. If the user is using a mobile telephone, the user may not want to interact via the small screen. However, the user can be connected with the advertiser by voice. If a button or hyperlink is used to initiate a telephone call, the user does not need to write down or try to remember a telephone number. Orders can be placed without requiring the user to scroll through various information and enter information using often limited keypads. Finally, advertisers are directly connected with advertisers.

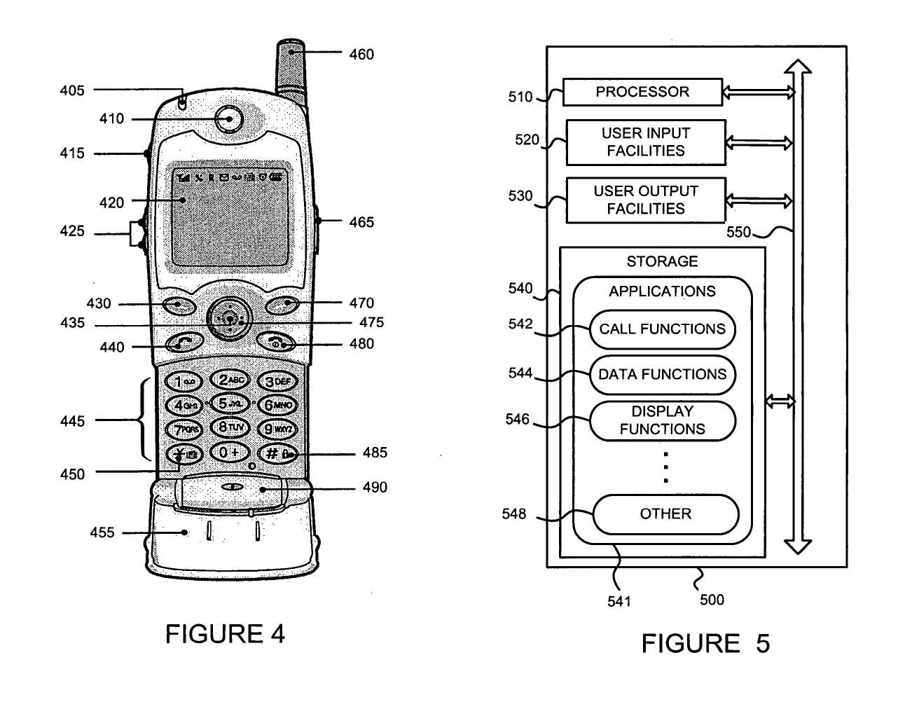

FIGS. 4 and 5 are diagrams of mobile telephones with which with the present invention may be used. The mobile telephone 400 of FIG. 4 may include one or more of a call indicator 405, an earpiece 410, a record key 415, a display screen 420, an up/down side key 425, a soft left key 430, an easy key 435, a send key 440, numeric keys 445, a star key 450, an active flip 455, an antenna 460, a handsfree connector 465, a soft right key 470, navigation keys 475, an end/power key 480, a hash or pound key 485 and a microphone 490.

FIG. 5 is a block diagram of a mobile telephone 500 with which the present invention may be used. The mobile telephone 500 may include one or more processors 510, one or more user input facilities 520 (e.g., keys and microphone), one or more user output facilities 530 (e.g., display and speaker) and one or more storage facilities 540. These facilities can communicate with one another via one or more buses or networks 550. The storage facilities 540 may include various applications 541, such as applications that support call functions 542, applications that support data functions 544, applications that support display functions 546, as well as additional applications 548. The data functions 544 may include browser functions. Finally application program interfaces (APIs) may be provided which allow data functions 544 to access call functions 542.

Currently, some telephones can extract telephone number information from short-message-service (SMS) messages (e.g., by looking for simple patterns ###-###-####, (###) ###-####, etc.) Therefore, an ad delivered in SMS can include a telephone number that will be recognized—and if selected can cause the telephone to dial the telephone number. Microsoft has already installed a feature in its pocket-PC Explorer which uses the following syntax:
<a href=“te1:12063722651”> call me</a>

which basically puts up a link that, if pressed, calls the telephone number in the “tel:” tag.

Most phones that support data and voice modes usually include a limited amount of interaction between the data and voice sides. However, dialing from a Web page is possible by having an application on the user device use APIs, available on many mobile telephones, to dial a telephone number that is often exposed to the data side. The mobile client applications may be developed using various commercially available platforms such as Binary Runtime Environment for Wireless ((BREW) from Qualcomm of SanDiego, Calif.), Java 2 Micro Edition ((J2ME) from Sun of Santa Clara, Calif.), Symbian, Smartphone, etc., for example. BREW and J2ME allow commands, such as initiative voice-call, to be sent to applications for the voice functions of the telephone.

### §4.2.1 Ad Request

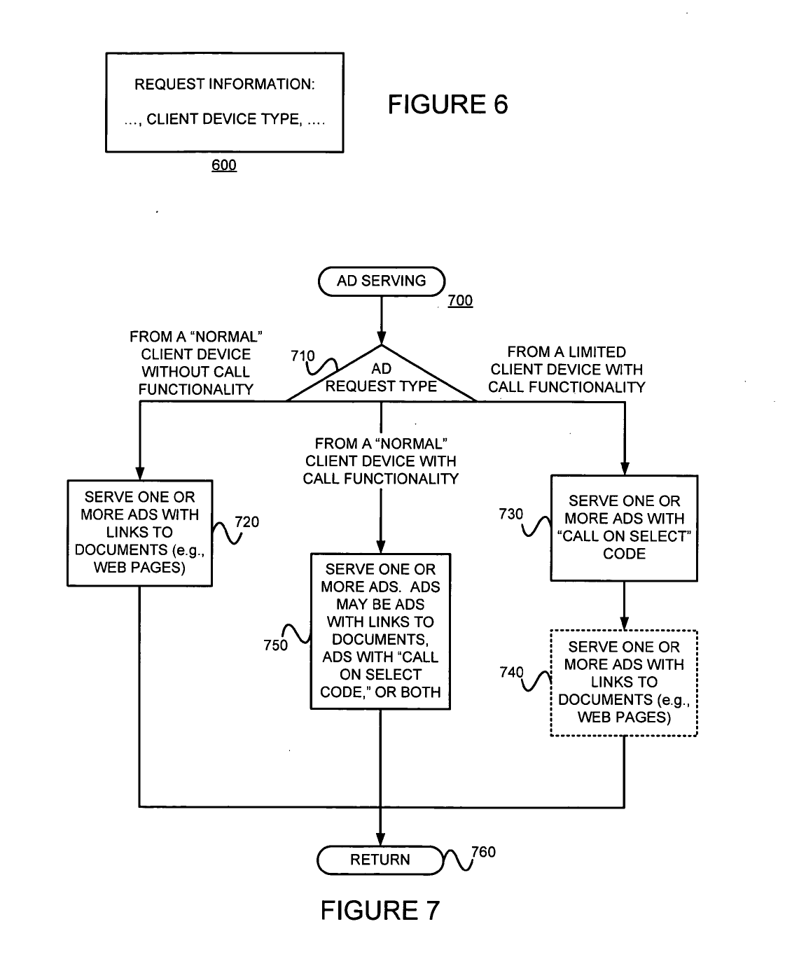

FIG. 6 illustrates an exemplary data structure 600 that is consistent with the present invention, for storing an ad request message. Among other things, such as information used for targeting relevant ads for example, the message 600 may include client device type information 600. Such client device type information may be used to determine one or more of (i) whether or not the user device has a small display, and/or a size of the display, (ii) whether or not the user device has a low resolution display, and/or the resolution of the display, (iii) whether or not the user device has a limited communications connection, and/or a speed of the connection (which may instead be inferred), (iv) whether or not the user device has a slow processor, and/or the speed of the processor, (v) whether or not the user device is limited in terms of loading and rendering a Web page, (vi) whether or not the user device has call functionality, (vii) whether or not the user device has supports various authoring languages (e.g., a HTML, SGML, XML, WAP, WAP 2.0, dHTML, xHTML, Java, Javascript, etc.), (vii) whether the user device is supporting a currently active (not terminated) telephone call, (viii) whether or not the user device has a limited user input, (ix) what type of user input is provided (e.g., touch screen, stylus, limited keypad, full keyboard, pointers, etc.), etc. Such user device information may be used in a determination of whether or not to serve certain ads or certain types of ads, and/or how to score competing ads.

Other ways of communication or inferring user device type may be used and the present invention is not limited to the foregoing message data structure, nor is it limited to the types of information listed.

### §4.2.2 Selection and/or Scoring of Ads

FIG. 7 is a flow diagram of an exemplary method 700 for performing ad serving operations in a manner consistent with the present invention. As indicated by block 710, different branches of the method 700 may be performed depending on an ad request type. If the ad request type is (sourced) from a “normal” client device without call functionality, one or more ads with links to documents (e.g., Web pages) are served (Block 720) before the method 700 is left (Node 760). Examples of such ads include keyword-targeted text ads. The ads may be served in accordance with an ad score. The score of an ad may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the ad (e.g., selection rate, user rating, conversion rate, etc.), etc. A “normal” client device is one that is not a limited client device. For example, a normal client device may be one with a normal display and/or a normal connection speed such as a personal computer for example.

Referring back to block 710, if the ad request type is (sourced) from a “normal” client device with call functionality, one or more ads can be served. The ad(s) may be ad(s) with links to documents, ad(s) with “call on select” code, or both. (Block 750) Thus, one or more ads with “call-on-select” code may be served, or at least compete for serving. For example, even if a user device can load and render a Web page in a way satisfactory to most users, or a group of target users, it may be advantageous to serve call-on-select ads since such ads may have a higher conversion rate, and/or may be expected to generate more revenue for the advertiser. This higher conversion rate may be reflected in the score of the ads. As was the case with block 720 of the left branch, the ads may be served in accordance with an ad score. The score of an ad may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the ad (e.g., selection rate, user rating, conversion rate, etc.), etc. In addition, the score of an ad may be a function of how the ad performs (e.g., in terms of selection rate, conversion rate, etc.) on devices with call functionality.

Referring back to block 710, if, on the other hand, the request type is from a “limited” client device with call functionality (e.g., a client device with a small display, a slow connection speed, and/or slow processing speed), the right branch of method 700 is performed. For example, one or more ads with call-on-select code may be served (Block 730) before the method 700 is left (Node 750). As shown, one or more ads with links to documents (e.g., Web pages) may also be served. (Block 740) As was the case with block 720 of the left branch, the ads may be served in accordance with an ad score. The score of an ad may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the ad (e.g., selection rate, user rating, conversion rate, etc.), etc. In addition, the score of an ad may be a function of how the ad performs (e.g., in terms of selection rate, conversion rate, etc.) on devices with call functionality and limited displays and/or limited communications connections.

In an alternative embodiment, as long as the user device has call functionality, all types of ads may be considered, but the score of the ads considers the user device type. For example, the user device type may affect a performance parameter of an ad used in determining the ad's score.

### §4.2.3 Exemplary Ad Displays

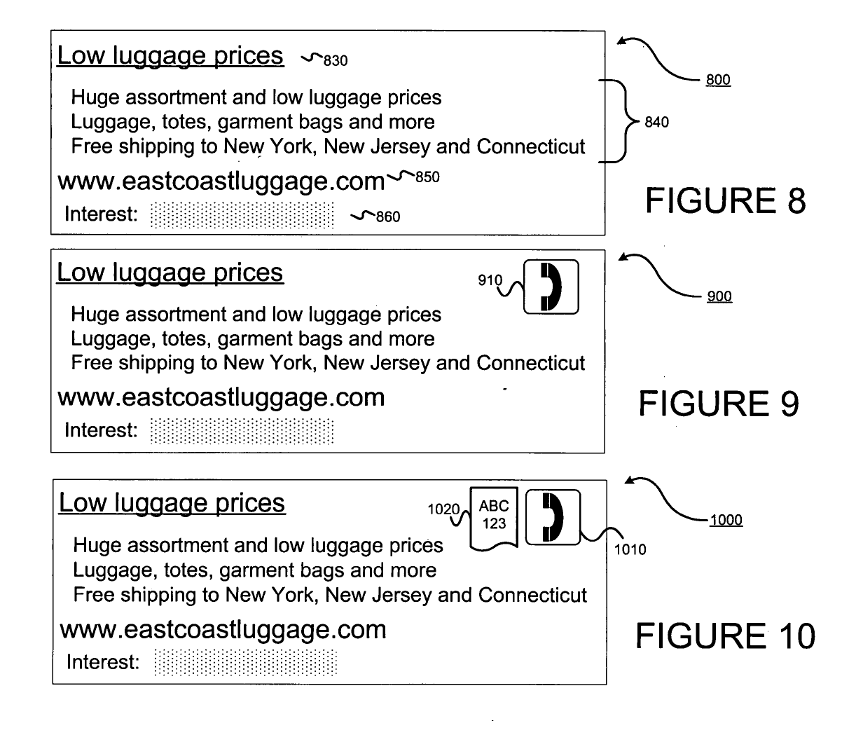

FIGS. 8-12 are exemplary ad displays consistent with the present invention. FIG. 8 is a text ad 800 which may include one or more of a title line 830, one or more lines of text 840, a World Wide Web address 850 and an interest meter 860. Typically, when such an ad is selected by a user clicking on the ad, an associated Web page is loaded onto the user's browser. However, as discussed above, this may not be desirable for certain user devices.

FIG. 9 is a text ad 900 which includes call-on-select functionality as indicated by icon button 910. In some embodiments of the present invention, a call (to a telephone number associated with the ad by the advertiser) is initiated when the icon button 910 is selected (e.g., via touch screen, stylus, keystroke, pointer, such as a joystick, a touchpad, a track call, etc.). Depending on the embodiment, if a portion of the ad 900 other than the icon button 910 is selected, a call can be initiated, or, alternatively, a linked document can be rendered on the browser of the device.

FIG. 10 is a text ad 1000 which includes call-on-select functionality as indicated by icon button 1010, as well as linked document functionality as indicated by icon button 1020. In some embodiments of the present invention, a call (to a telephone number associated with the ad by the advertiser) is initiated when the icon button 1010 is selected and a linked document is rendered on the browser when the icon button 1020 is selected. Depending on the embodiment, if a portion of the ad 1000 other than the icons buttons 1010 and 1020 is selected, a call can be initiated, or, alternatively, a linked document can be rendered on the browser of the device.

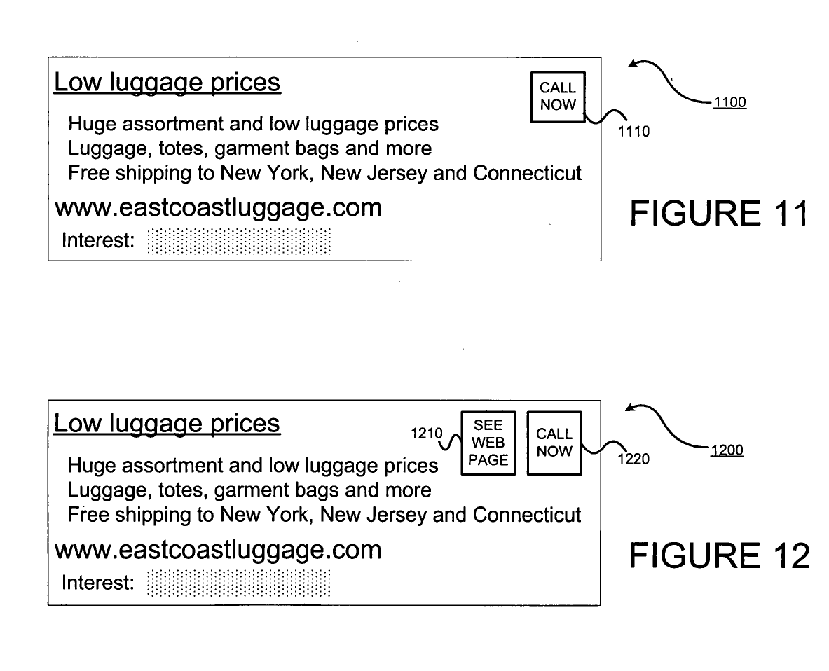

FIG. 11 is a text ad 1100 which includes call-on-select functionality as indicated by button 1110. In some embodiments of the present invention, a call (to a telephone number associated with the ad by the advertiser) is initiated when the button 1110 is selected. Depending on the embodiment, if a portion of the ad 1100 other than the button 1110 is selected, a call can be initiated, or, alternatively, a linked document can be rendered on the browser of the device.

FIG. 12 is a text ad 1200 which includes call-on-select functionality as indicated by button 1210, as well as linked document functionality as indicated by button 1220. In some embodiments of the present invention, a call (to a telephone number associated with the ad by the advertiser) is initiated when the button 1210 is selected and a linked document is rendered on the browser when the button 1220 is selected. Depending on the embodiment, if a portion of the ad 1000 other than the buttons 1210 and 1220 is selected a call can be initiated, or, alternatively, a linked document can be rendered on the browser of the device. Before, concurrent with, or after the call initiation, informational messages (e.g., “YOU ARE NOW CALLING ______” can be rendered on the telephone).

Ads with both call and linked document functionality may have different performance parameters associated with the different functionality. Alternatively, or in addition, the ad may have different offers associated with different user actions (e.g., a first offer for a call and a second offer for a linked document referral). Referring back to method 700, the scoring of ads may consider one or more of the different performance parameters and/or one more of the different offers.

Various alternative functionality of the ads described above may be performed depending on one or more of default values of the ad server, advertiser preferences, user or user set preferences, content owner preferences, content owner group preferences, etc.

Although text ads were shown in FIGS. 8-12, other types of ads, such as those listed in §4.1.1. above, can be used in a manner consistent with the present invention. Further, different ways of navigating to (a) loading a document and/or (b) dialing a telephone number are possible. For example, when a user selects an ad, they may be asked whether they want to visit the advertiser's Web page or talk to the advertiser.

### §4.2.4 Ad Selection Responsive Actions

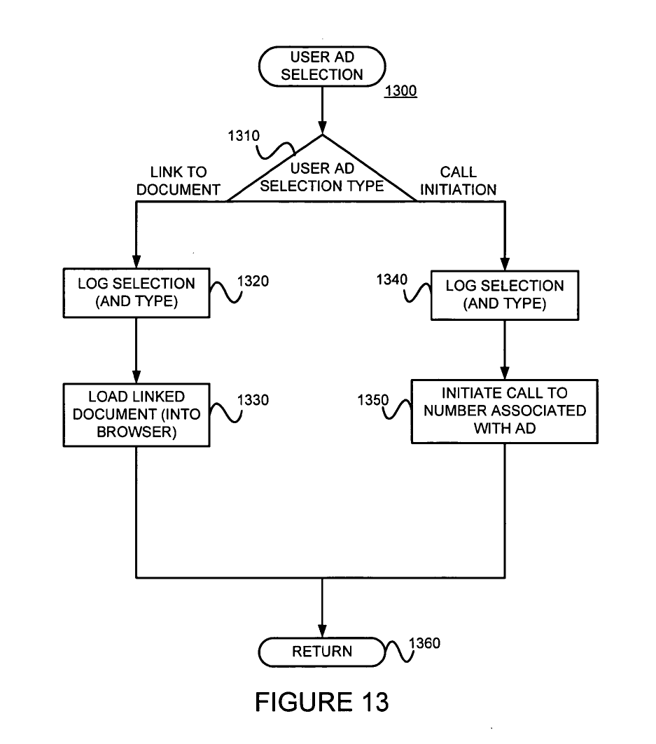

FIG. 13 is a flow diagram of an exemplary method 1300 for performing user ad selection operations in a manner consistent with the present invention. As indicated by block 1310, different branches of the method 1300 may be performed depending on a user ad selection type. (Recall, e.g., ads 900, 1000, 1100 and 1200 described above.) If the user ad selection type is a link to document, the left branch of the method 1300 is performed, while if the user ad selection type is a call initiation, the right branch of the method 1300 is performed.

If the user ad selection is a link to document, the ad selection (and type) may be logged (Block 1320) and the linked document may be rendered on the user device (e.g., loaded into a browser) (Block 1330), before the method 1300 is left (Node 1360). If, on the hand, the user ad selection is a call initiation, the ad selection (and type) may be logged (Block 1340) and a call to a number associated with the ad may be initiated (Block 1350) before the method 1300 is left (Node 1360). Although not shown, other user actions may be logged (e.g., conversion, user terminating the call before establishment or before a certain point, etc.).

### §4.2.5 Exemplary Apparatus

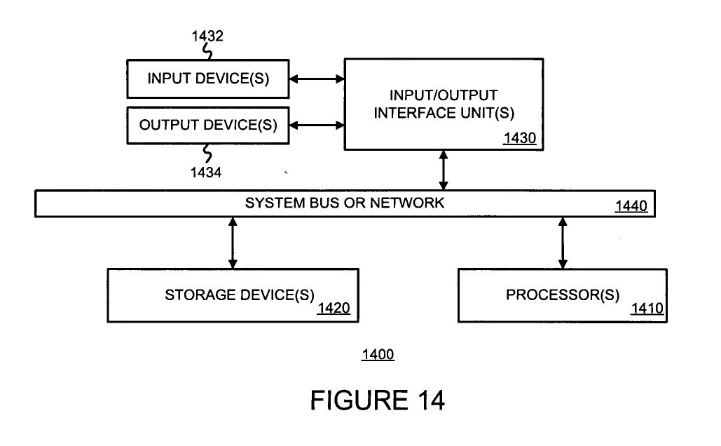

FIG. 14 is high-level block diagram of a machine 1400 that may perform one or more of the operations discussed above. The machine 1400 includes one or more processors 1410, one or more input/output interface units 1430, one or more storage devices 1420, and one or more system buses and/or networks 1440 for facilitating the communication of information among the coupled elements. One or more input devices 1432 and one or more output devices 1434 may be coupled with the one or more input/output interfaces 1430.

The one or more processors 1410 may execute machine-executable instructions (e.g., C or C++ running on the Solaris operating system available from Sun Microsystems Inc. of Palo Alto, Calif., the Linux operating system widely available from a number of vendors such as Red Hat, Inc. of Durham, N.C., the BREW or J2ME applications platforms, the Symbian operating system from Symbian of London, UK, Java, assembly, Perl, etc.) to effect one or more aspects of the present invention. At least a portion of the machine executable instructions may be stored (temporarily or more permanently) on the one or more storage devices 1420 and/or may be received from an external source via one or more input interface units 1430.

In one embodiment, the machine 1400 may be one or more conventional personal computers, mobile telephones, PDAs, etc. In the case of a conventional personal computer, the processing units 1410 may be one or more microprocessors. The bus 1440 may include a system bus. The storage devices 1420 may include system memory, such as read only memory (ROM) and/or random access memory (RAM). The storage devices 1420 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1432, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1410 through an appropriate interface 1430 coupled to the system bus 1440. The output devices 1434 may include a monitor or other type of display device, which may also be connected to the system bus 1440 via an appropriate interface. In addition to (or instead of) the monitor, the personal computer may include other (peripheral) output devices (not shown), such as speakers and printers for example.

The machine 1400 may be a mobile telephone such as those 400 and 500 illustrated in FIGS. 4 and 5, respectively.

Referring back to FIG. 2, one or more machines 1400 may be used as ad server 210, search engine 220, content server 230, e-mail server 240, and/or user device 250.

### §4.2.6 Alternatives and Extensions

In at least some embodiments consistent with the present invention, call-on-select ads are only served and/or have selection enabled if the telephone number is a local telephone number. Such embodiments would avoid long distance calls. This feature may be linked with a calling plan of the user device.

Not all ad links need to have telephone numbers associated with them. In at least some embodiments consistent with the present invention, the user is given an option (either before or after ad selection) of making a voice call or going to the Web page. As shown in FIGS. 10 and 12 above, separate buttons with separate links for Web page display or voice calls can be provided. Alternatively, the advertiser can decide this. As yet another alternative, whether to display a Web page or make a voice call may be determined by pre-existing user preferences.

To avoid user confusion, at least some embodiments consistent with the present invention may enforce the use of a consistent user interface across all ads. The advertisers may be forced to have their ads conform to such a consistent format when entering ads into the ad system, or a format conversion from a non-compliant format to the consistent format may occur later.

Advertisers can chose to offer different amounts for document (e.g., Web page) load-on-selection and call-on-selection. Performance parameters for each can be tracked separately.

The telephone number can be included as data and sent in variety of forms. It does not even need to be interpreted by standard HTML browsers. It can be sent as meta data in the header of the page returned. Alternatively, or in addition, it can be sent as comments with the each advertisement. Alternatively, or in addition, it can be sent as structured data. Alternatively, or in addition, it can be sent as a “tel:XXX” tag. The first and second options are useful in cases in which the renderer is not known or under control of the ad server (for example if it is shown in a browser that does not support tel links). In such cases the telephone call functionality may not exist and the phone number will simply be ignored. The third option is useful if a structured feed is returned to the user device. For example, search results may be returned to a mobile telephone in an XML formatted feed. Advertisements and all the related advertisement fields can also be formatted in XML (or any other structured language). The XML is treated as a data feed and the rendering is all dictated by the intelligence built into a client application on the user device.

In at least some embodiments consistent with the present invention, the call-on-select telephone number may connect the client to an audio document (e.g., a voice message) or a live operator, depending on the telephone number specified by the advertiser. Although not shown in FIGS. 8-12, different buttons can be used to indicate whether the call will be placed to an audio document or a live operator.

In at least some embodiments consistent with the invention, selecting an ad or a button on an ad may initiate both a call and a document-load. The call initiation and document-load initiation may occur in parallel or in series. In still another alternative embodiment consistent with the present invention, a limited document (e.g., in terms of time to load and render) with one or more call-on-select links can be loaded in response to an ad selection. For example, rather than load a large Web page, a limited document stating:
CLICK HERE TO SPEAK WITH A TRAVEL AGENT
CLICK HERE TO HEAR ABOUT SPECIAL PROMOTIONS
may be loaded.

Although some of the exemplary embodiments described the use of a browser, at least some embodiments consistent with the present invention may use some other content rendering application or device.

### §4.3 Examples of Operations

The following examples illustrate the utility of an exemplary embodiment of the present invention. In a first example, assume that there are five ads with at least the following information:
AD 1: landing page: www.fareasttaste.com
offer-per-selection_{doc}: $0.10
selection rate_{doc}: 0.05
call-on-select number: NONE
offer-per-selection_{call}: NONE
selection rate_{call}: NONE
AD 2: landing page: www.siamgarden.com
offer-per-selection_{doc}: $0.05
selection rate_{doc}: 0.05
call-on-select number: 1-234-567-8910
offer-per-selection_{call}: $0.25
selection rate_{call}: 0.15
AD 3: landing page: www.noodles.com
offer-per-selection_{doc}: $0.50
selection rate_{doc}: 0.12
call-on-select number: 1-234-109-8765
offer-per-selection_{call}: $0.30
selection rate_{call}: 0.20
AD 4: landing page: NONE
offer-per-selection_{doc}: NONE
selection rate_{doc}: NONE
call-on-select number: 1-234-789-1011
offer-per-selection_{call} $0.50
selection rate_{call}: 0.13
AD 5: landing page: NONE
offer-per-selection_{doc}: NONE
selection rate_{doc}: NONE
call-on-select number: 1-234-111-2222
offer-per-selection_{call}: $0.05
selection rate_{call}: 0.05

Assume further that an ad score is the product of offer per selection and selection rate. Finally, assume that if the user device requesting the ad has a limited display, that the score_{doc} is reduced by a factor of 20 (based on an assumption that the selection rate for selecting an ad with a linked document is much less on a device with a limited display than on a device with a normal display).

Assume, now that AD 1 through AD 5 are eligible for a first request from a personal computer (normal display assumed) without call functionality. The ads may be scored and ranked as shown in TABLE I.

TABLE I

| | | SELECTION | | |
|---|---|---|---|---|
| AD | OFFER_{DOC} | RATE_{DOC} | SCORE | RANK |
| AD 1 | $0.10 | 0.05 | 0.0050 | 2 |
| AD 2 | $0.05 | 0.05 | 0.0025 | 3 |
| AD 3 | $0.50 | 0.12 | 0.0600 | 1 |
| AD 4 | NONE | NONE | NONE | |
| AD 5 | NONE | NONE | NONE | |

Notice that since AD 4 and AD 5 don't have linked documents and since the requesting user device doesn't have call functionality, otherwise eligible ads aren't scored (or are given a default score of 0.0000 for example). In some embodiments, such ads aren't served to avoid user confusion and frustration and so that a user's attention isn't taken away from AD 1 through AD 3.

Assume now that AD 1 through AD 5 are eligible for a second request from a mobile telephone (limited display) with support for call-on-select functionality. The ads may be scored and ranked as shown in TABLE II.

TABLE II

| | | SELETION | | | SELECTION | |
|---|---|---|---|---|---|---|
| AD | OFFER_{DOC} | RATE_{DOC} | SCORE_{DOC} | OFFER_{CALL} | RATE_{CALL} | SCORE_{CALL} |
| AD 1 | $0.10 | 0.05 | 0.000250 | NONE | NONE | NONE |
| AD 2 | $0.05 | 0.05 | 0.000125 | $0.25 | 0.15 | 0.0375 |
| AD 3 | $0.50 | 0.12 | 0.003000 | $0.30 | 0.20 | 0.0600 |
| AD 4 | NONE | NONE | NONE | $0.50 | 0.13 | 0.0650 |
| AD 5 | NONE | NONE | NONE | $0.05 | 0.05 | 0.0025 |

An overall score may be a function of one or both of the score_{doc} and score_{call}. For example, an overall score may be MAX{score_{doc}, score_{call}}. Alternatively, an overall score may be score_{doc}+score_{call}. Assume, for this example, that the overall score is the maximum of the score_{doc} and score_{call}. The rank of the ads, from highest to lowest, would be AD 4, AD 3, AD 2, AD 5. Notice that even if AD 3 didn't have a call-on-select offer and functionality, its document score would still have been better than the call score of AD 5.

Finally, assume now that AD 1 through AD 5 are eligible for a third request from a laptop computer (normal display assumed) with support for call-on-select functionality. The ads may be scored and ranked as shown in TABLE III.

TABLE III

| | | SELECTION | | | SELECTION | |
|---|---|---|---|---|---|---|
| AD | OFFER_{DOC} | RATE_{DOC} | SCORE_{DOC} | OFFER_{CALL} | RATE_{CALL} | SCORE_{CALL} |
| AD 1 | $0.10 | 0.05 | 0.0050 | NONE | NONE | NONE |
| AD 2 | $0.05 | 0.05 | 0.0025 | $0.25 | 0.15 | 0.0375 |
| AD 3 | $0.50 | 0.12 | 0.0120 | $0.30 | 0.20 | 0.0600 |
| AD 4 | NONE | NONE | NONE | $0.50 | 0.13 | 0.0650 |
| AD 5 | NONE | NONE | NONE | $0.05 | 0.05 | 0.0025 |

Notice that in this case, since the user device has a full display, the document scores are not reduced. The final ranking may depend on how the overall score is determined using one or both of the score_{doc} and score_{call}. For example, these scores may be combined in a un-weighted or weighted manner (e.g., as specified by the advertiser, as specified by the ad serving system, and/or accounting for user behavior with respect to call-on-select and document-load-on-select ads).

### §4.4 Conclusions

As can be appreciated from the foregoing, the present invention permits an ad server to better monetize searches and document requests, such as those on devices like mobile telephones that support call-on-select functionality, while permitting the avoidance of poor user experiences on such devices such as those due to small displays on such devices, slow communications connections and/or processors on such devices, and/or limits of user input on such devices. Further, in the same way that cost-per-selection yields higher offers and revenues than cost-per-impression, cost-per-call may yield higher offers and revenues than cost-per-selection (with an ad landing Web page being loaded upon selection) since the advertiser can talk directly with a potential customer.

1.-20. (canceled)

21. A system for device configuration-based function delivery, comprising:
a server comprising one or more processors and memory to:
receive, from a computing device via a computer network, a data structure including device configuration information that indicates the computing device comprises an application programming interface to allow a command to access a type of function of the computing device;
identify, responsive to a request from the computing device that accessed an online resource having content, a first content item having the command corresponding to the type of function and a second content item without the command corresponding to the type of function;
determine, based on the content of the online resource accessed by the computing device, a first document score for the first content item and a second document score for the second content item, the second document score greater than the first document score;
determine, based on the device configuration information that indicates the computing device comprises the application programming interface to allow the command to access the type of function of the computing device, a first function score for the first content item having the command and a second function score for the second content item without the command, the second function score less than the first function score;
combine the first document score with the first function score to generate a first overall score for the first content item;
combine the second document score with the second function score to generate a second overall score for the second content item, the second overall score less than the first overall score; and
select, based on the first overall score being greater than the second overall score, the first content item with the command for transmission, via the computer network, to the computing device comprising the application programming interface to cause the command to access the type of function of the computing device.

22. The system of claim 21, comprising:
the server configured to transmit the first content item with the command to the computing device comprising the application programming interface to cause the command to access the type of function of the computing device responsive to selection of the first content item.

23. The system of claim 21, comprising:
the server configured to transmit the first content item with the command to the computing device comprising the application programming interface to cause the command to access the type of function of the computing device responsive to a voice initiated command.

24. The system of claim 21, comprising:
the server configured to transmit the first content item with the command to the computing device comprising the application programming interface to cause the command to access the type of function of the computing device responsive to voice detected by a microphone of the computing device.

25. The system of claim 21, wherein the first content item comprises audio, comprising the server to:
transmit, to the computing device, the first content item comprising the audio and the command to cause the command to access the type of function of the computing device responsive to voice detected by a microphone of the computing device.

26. The system of claim 21, wherein the first content item comprises audio, comprising the server to:
transmit, to the computing device, the first content item comprising the audio and the command to cause the command to access the type of function of the computing device responsive to voice detected by a microphone of the computing device, the type of function of the computing device configured to connect the computing device to a voice message.

27. The system of claim 21, wherein the online resource comprises at least one of a document, web page, audio file, or video file.

28. The system of claim 21, wherein the type of function comprises a call function, and the command comprises a call-on-select function.

29. The system of claim 21, wherein the type of function comprises a call function, and the command comprises a voice-initiated call.

30. The system of claim 21, comprising:
the server configured to receive, from the computing device, a message that indicates the computing device is supporting a currently active telephone call.

31. The system of claim 21, comprising:
the server configured to receive, from the computing device, one or more messages that indicate at least one of a type of input supported by the computing device or a type of authoring language supported by the computing device.

32. A method for device configuration-based function delivery, comprising:
receiving, by a server comprising one or more processors and memory, from a computing device via a computer network, a data structure including device configuration information that indicates the computing device comprises an application programming interface to allow a command to access a type of function of the computing device;
identifying, by the server responsive to a request from the computing device that accessed an online resource having content, a first content item having the command corresponding to the type of function and a second content item without the command corresponding to the type of function;
determining, by the server, based on the content of the online resource accessed by the computing device, a first document score for the first content item and a second document score for the second content item, the second document score greater than the first document score;
determining, by the server, based on the device configuration information that indicates the computing device comprises the application programming interface to allow the command to access the type of function of the computing device, a first function score for the first content item having the command and a second function score for the second content item without the command, the second function score less than the first function score;
combining, by the server, the first document score with the first function score to generate a first overall score for the first content item;
combining, by the server, the second document score with the second function score to generate a second overall score for the second content item, the second overall score less than the first overall score; and
selecting, by the server, based on the first overall score being greater than the second overall score, the first content item with the command for transmission, via the computer network, to the computing device comprising the application programming interface to cause the command to access the type of function of the computing device.

33. The method of claim 32, comprising:
transmitting the first content item with the command to the computing device comprising the application programming interface to cause the command to access the type of function of the computing device responsive to selection of the first content item.

34. The method of claim 32, comprising:
transmitting the first content item with the command to the computing device comprising the application programming interface to cause the command to access the type of function of the computing device responsive to a voice initiated command.

35. The method of claim 32, comprising:
transmitting the first content item with the command to the computing device comprising the application programming interface to cause the command to access the type of function of the computing device responsive to voice detected by a microphone of the computing device.

36. The method of claim 32, wherein the first content item comprises audio, the method comprising:
transmitting, to the computing device, the first content item comprising the audio and the command to cause the command to access the type of function of the computing device responsive to voice detected by a microphone of the computing device.

37. The method of claim 32, wherein the first content item comprises audio, the method comprising:
transmitting, to the computing device, the first content item comprising the audio and the command to cause the command to access the type of function of the computing device responsive to voice detected by a microphone of the computing device, the type of function of the computing device configured to connect the computing device to a voice message.

38. The method of claim 32, wherein the online resource comprises at least one of a document, web page, audio file, or video file.

39. The method of claim 32, wherein the type of function comprises a call function, and the command comprises a voice-initiated call.

40. The method of claim 32, comprising:
receiving, from the computing device, one or more messages that indicate at least one of a type of input supported by the computing device or a type of authoring language supported by the computing device.
